(19) United States
(12) Patent Application Publication
(10) Pub. No.: US 2002/0088682 A1
(43) Pub. Date: Jul. 11, 2002

(54) Manual clutch for an electric garage door

(76) Inventor: Chung-Min Chang, Taichung (TW)

Correspondence Address: THORP REED & ARMSTRONG, LLP, ONE OXFORD CENTRE, 301 GRANT STREET, 14TH FLOOR, PITTSBURGH, PA, 15219-1425, US

(21) Appl. No.: 09/758,760

(22) Filed: Jan. 11, 2001

(51) Int. Cl. E05F 11/54; E05C 19/00

(52) U.S. Cl. 192/30 R; 49/139

(57) ABSTRACT

A clutch for an electric garage door includes a sliding base slidably mounted on a rail that is mounted in the garage. The sliding base includes two chain passages defined in two opposite sides thereof. A pawl is retractably mounted in the sliding base and partially extends into the first chain passage. A connection block is attached to a chain and is driven by the drive device. The connection block includes a cavity defined to receive the pawl in the first chain passage. Then the sliding base can be moved to pull and open the door because a linkage is connected between the sliding base and the door. The pawl is moved down from the cavity of the connection block when the cable is pulled. Consequently, the sliding base can be manually moved to open the door when there is a power failure.

### BACKGROUND OF THE INVENTION

1. Field of the Invention The present invention relates to a clutch, and more particularly to a manual clutch for an electric garage door that can disconnect the garage door from the drive device so the door can be opened manually when there is a power failure.

2. Description of Related Art

A conventional electric garage door usually comprises a drive device such as a motor that is mounted on the wall near the top of the door to drive a chain. A sliding base is secured on the chain and a linkage is connected to the sliding base and the door. The sliding base is moved by the drive device to pull the linkage to open the door of the garage. Most electric garage doors further include a remote control device to make operation of the door more convenient. However, most electric garage doors are virtually impossible or are extremely difficult to open when there is a power failure because the conventional electric garage door does not have a clutch to release the sliding base from the drive device so the door can be opened manually.

The present invention has arisen to mitigate and/or obviate the disadvantages of the conventional electric garage door.

### SUMMARY OF THE INVENTION

In accordance with one aspect of the present invention, a manual clutch for an electric garage door is provided so an electric garage door can be easily opened when there is a power failure. The manual clutch comprises a sliding base and a connection block. The sliding base is attached to the garage door and slidably mounted on a horizontal rail mounted inside the garage. The connection block is securely attached to the drive chain.

The sliding base comprises two chain passages, a pawl and a pawl actuating assembly. A first chain passage and a chain second passage are defined in opposite sides of the sliding base parallel to the rail and each other. The pawl is rectangular, is retractably mounted in the sliding base and partially extends into the first chain passage. The pawl actuating assembly normally causes the pawl to extend into the first chain passage and can retract the pawl from the first chain passage. A connection block is attached to and driven with the chain. The connection block includes a cavity defined to receive the pawl in the first chain passage in the sliding base and detachably connect the sliding base to the chain. Then the sliding base can be moved to pull and open the door because a linkage connects the sliding base and the door. One end the rectangular pawl extends through the sliding base and has a cable attached to the pawl. The pawl is moved out of the cavity in the connection block when the cable is pulled. With the pawl released from the cavity, the sliding base can be moved manually to open the door when there is a power failure.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a manual clutch for an electric garage door in accordance with the present invention;

FIG. 2 is an exploded perspective view of the manual clutch in FIG. 1;

FIG. 3 is a side plan view in partial section of the manual clutch in FIG. 1;

FIG. 4 is a cross sectional rear plan view of the manual clutch along the line 4-4 in FIG. 3;

FIG. 5 is an operational side plan view of the manual clutch in FIG. 1; and

FIG. 6 is an operational side plan view of the manual clutch in FIG. 1 connected to a garage door.

### DETAILED DESCRIPTION OF THE INVENTION

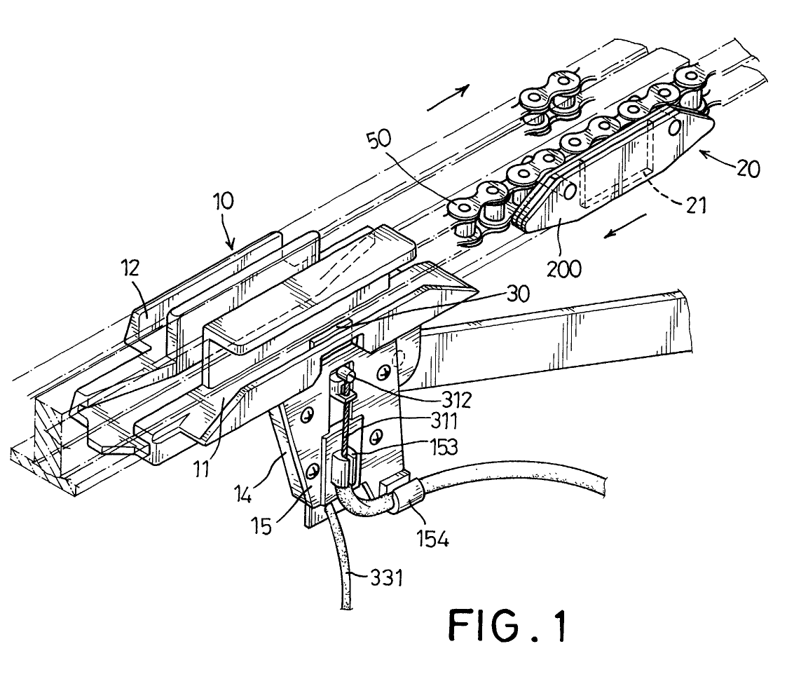

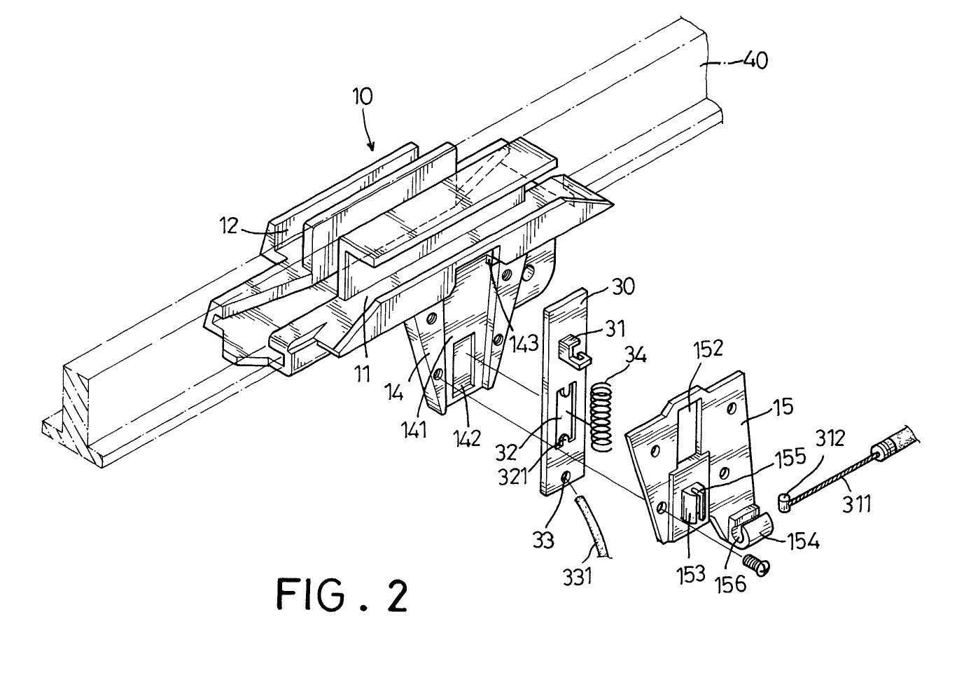

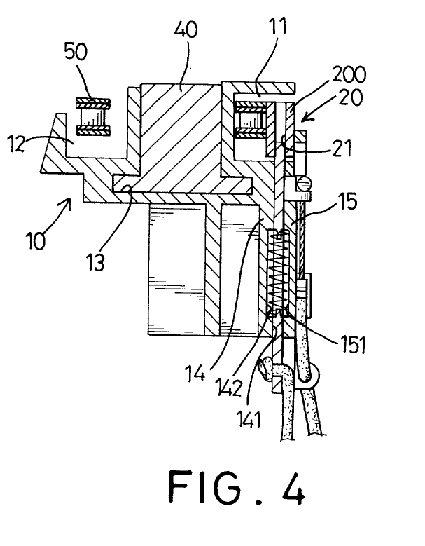

With reference to the drawings and initially to FIGS. 1 to 4, a manual clutch for an electric garage door in accordance with the present invention comprises a sliding base (10) and a connection block (20). The sliding base (10) is slidably mounted on a rail (40) and is connected to the garage door with a linkage. The rail (40) is an inverted T-shape and is horizontally mounted on the wall or ceiling of a garage. The connection block (20) is securely attached to a drive chain (50) and detachably connects to the sliding base (10) to firmly attach the sliding base (10) to the chain (50).

The sliding base (10) includes an inverted T-shaped groove (13), a first chain passage (11), a second chain passage (12), a tongue (14), a pawl (30) and a pawl actuating assembly. The inverted T-shaped groove (13) is defined to receive the inverted T-shaped rail (40). The first chain passage (11) and the second chain passage (12) are defined on opposite sides of the sliding base (10) parallel to the inverted T-shaped rail (40). The tongue (14) extends vertically down from the sliding base (10) below the first chain passage (11). The pawl (30) and the pawl actuating assembly are mounted on the tongue (14). A groove (141) is longitudinally defined in the tongue (14) and communicates with the first chain passage (11) of the sliding base (10). A first recess (142) is defined in the bottom of the groove (141). Two positive stops (143) respectively extend from two opposite sidewalls of the groove (141) near the first passage (11) of the sliding base (10).

The pawl (30) is slidably received in the groove (141). The pawl (30) includes a first end extending into the first chain passage (11) in the sliding base (10) and a second end extending out from the tongue (14). A through hole (33) is defined in the second end of the pawl (30) and a cord (331) with one end fixed in the through hole (33) of the pawl (30). A first through slot (32) corresponding to the first recess (142) in the tongue (14) is longitudinally defined in the pawl (30). A hook (31) is formed on one side of the pawl (30) opposite to the groove (141) between the first slot (32) and the first end of the pawl (30). An end piece (312) is attached to one end of a cable (311) and is connected to the hook (31). The other end of the cable (311) extends through the door for outside use. Two bosses (321) are respectively formed on two opposite ends of the first slot (32) and aligning with each other. A spring (34) is compressively mounted in the first slot (32) with the ends of the spring (34) mounted around the two bosses (321) to hold the spring (34) in place. The spring (34) has a diameter greater than the thickness of the pawl (30) such that the spring extends laterally into the first recess (142) in the tongue (14).

A plate (15) is attached to the tongue (14) to close the groove (141) and prevent the pawl (30) from detaching from the tongue (14). The plate (15) includes a second recess (151) defined to face and correspond to the first recess (142) in the tongue (14). The spring (34) extends laterally into the second recess (141) in the plate (15). A second through slot (152) is defined in the plate (15) above the second recess (151). The hook (31) on the pawl (30) extends through and can move in the second through slot (152). The plate (15) includes a first side abutting the tongue (14) and a second side having a first cable holder (153) and a second cable holder (154). The first cable holder (153) has a groove (155) defined to receive the cable (311) toward the hook (31). The second cable holder (154) has a groove (156) defined to receive the cable (311) and is oriented perpendicular to the groove (155) in the first holder (153).

The connection block (20) is connected to a chain (50) that is driven by a motor. The connection block (20) includes two plates (200) each having a recess corresponding to each other and forming a groove (21) after abutting each other. The first end of the pawl (30) is received in the groove (21) of the connection block (20) to connect the sliding base (10) to the chain (50) of the drive device. Two opposite ends of the connection block (20) each has a guiding portion formed to guide the first end of the pawl (30) to slide into the groove (21) of the connection block (20). Then the drive device can drive the manual clutch for an electric garage door in accordance with the present invention.

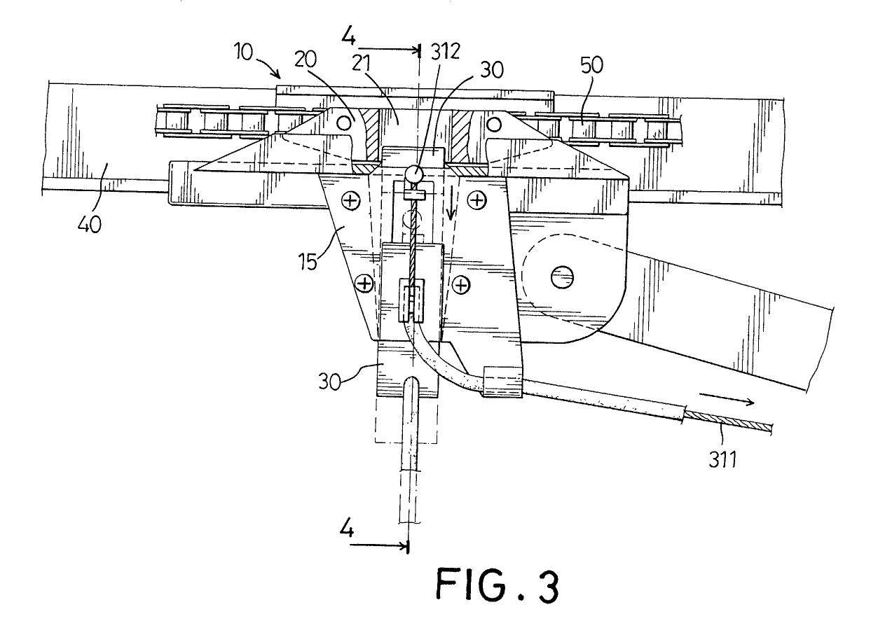

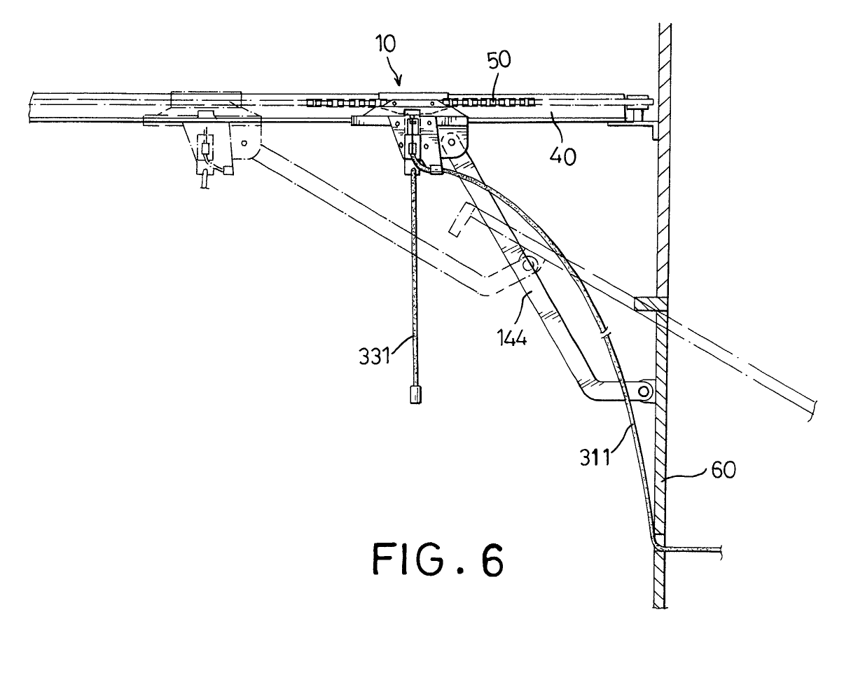

In operation, with reference to the FIGS. 3 and 6, an L-shaped linkage (144) is connected to the sliding base (10) and the door (60). The linkage (144) includes a first arm and a second arm respectively pivotally connected to the sliding base (10) and the door (60). The first arm is longer than the second arm. The sliding base (10) pulls the door up and opens the door when the drive device drives the sliding base (10) backward relative to the door (60).

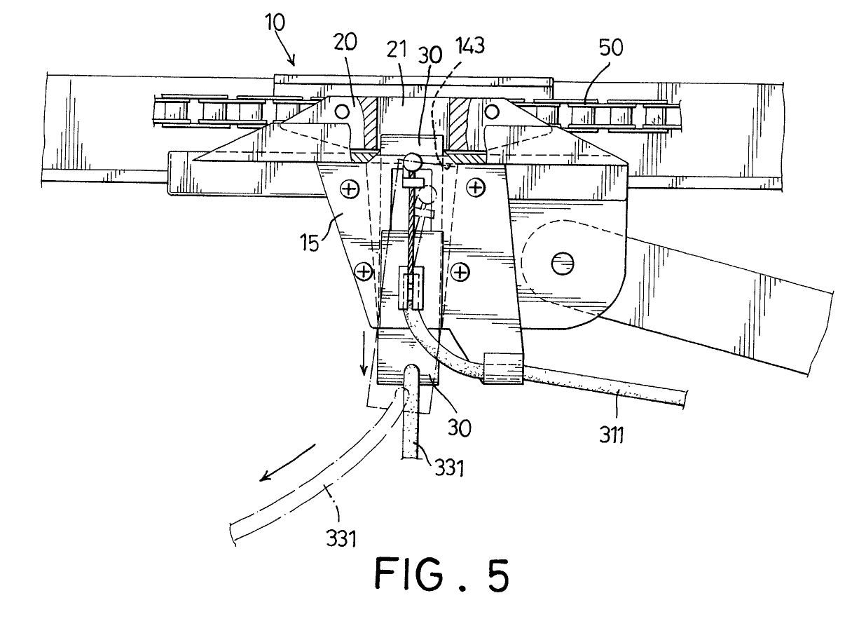

With reference to the FIGS. 5 and 6, during a power failure, the user can pull the cord (331) inside or the cable (311) outside to detach the pawl (30) from the groove (21) in the connection block (20) and cause the pawl (30) to abut the positive stop (143). Then the door (60) can easily be pulled up manually and opened because the sliding base (10) can freely slide on the rail (40). If the cord (331) or the cable (311) is pulled again, the first end of the pawl (30) will move into the groove (21) in the connection block (20). Consequently, the manual clutch for an electric garage door in accordance with the present invention can allow the electric garage door to be opened easily even during a power failure.

Although the invention has been explained in relation to its preferred embodiment, it is to be understood that many other possible modifications and variations can be made without departing from the spirit and scope of the invention as hereinafter claimed.

What is claimed is:

1. A manual clutch for an electric garage door comprising:
a sliding base including a groove defined in a top of the sliding base, a first chain passage and second chain passage defined in two opposite sides of the sliding base parallel to the groove;
a tongue extending from the sliding base below a corresponding one of the two chain passages in the sliding base;
a plate attached to the tongue and forming a groove between the tongue and the plate, the plate having a first through slot defined near the sliding base;
at least one positive stop laterally extending into the groove and between the tongue and plate;
a pawl slidably mounted in the groove between the tongue and the plate, and having a first end extending into a corresponding one of the two chain passages in the sliding base and a second end extending out of the groove between the tongue and the plate, the pawl having a second through slot longitudinally defined to receive a spring, the spring held in place by the tongue and the plate, the spring having a diameter greater than a thickness of the pawl; and
a connection block slidably received in one of the two passages of the sliding base and corresponding to the tongue, the connection block having a groove defined to receive the first end of the pawl.

2. The manual clutch for an electric garage door as claimed in claim 1, wherein the groove in the sliding base is an inverted T-shape.

3. The manual clutch for an electric garage door as claimed in claim 1, wherein the tongue extends below the first chain passage in the sliding base.

4. The manual clutch for an electric garage door as claimed in claim 3, wherein the tongue comprises a groove defined to communicate with the first chain passage in the sliding base and movably receive the pawl, a first recess defined in the bottom of the groove and corresponding to the first slot in the pawl, and the spring extends laterally into the first recess of the tongue.

5. The manual clutch for an electric garage door as claimed in claim 4, wherein the plate comprises a second recess defined to correspond to the first recess in the tongue, and the spring laterally extends into the second recess.

6. The manual clutch for an electric garage door as claimed in claim 1, wherein the tongue extends below the second chain passage in the sliding base.

7. The manual clutch for an electric garage door as claimed in claim 6, wherein the plate comprises a groove defined to communicate with the second passage and movably receive the pawl, a second recess defined in the bottom of the groove of the plate and corresponding to the first slot of the pawl, the spring laterally extends into the second recess in the plate.

8. The manual clutch for an electric garage door as claimed in claim 7, wherein the tongue comprises a first recess defined to correspond to the second recess in the plate, and the spring extends laterally into the second recess.

9. The manual clutch for an electric garage door as claimed in claim 1, the plate comprises a second slot defined above the second recess, the pawl comprises a hook extending through and moved within the second slot, and a cable has a first end attached to the hook and a second end extending outside.

10. The manual clutch for an electric garage door as claimed in claim 9, the plate comprises a first cable holder having a groove defined to receive the cable toward the hook, and a second cable holder having a groove defined to receive the cable and being perpendicular to the groove in the first cable holder.

11. The manual clutch for an electric garage door as claimed in claim 1, wherein a through hole is defined in the second end of the pawl, and one end of a rope is fixed in the through hole in the pawl.

12. The manual clutch for an electric garage door as claimed in claim 1, wherein the connection block comprises two plates each having a recess corresponding to each other and forming a groove after abutting each other.

13. The manual clutch for an electric garage door as claimed in claim 1, wherein the connection block comprises two opposite ends each having a guiding portion formed to guide the first end of the pawl to slide into the groove of the connection block.
